(19) United States
(12) Patent Application Publication
(10) Pub. No.: US 2009/0057086 A1
(43) Pub. Date: Mar. 5, 2009

(54) HYDRAULIC POWER TRANSMISSION WITH LOCK-UP CLUTCH

(75) Inventors: Yuito ABE, Anjo-shi (JP); Keizo Araki, Anjo-shi (JP); Kazuyoshi Ito, Anjo-shi (JP); Akitomo Suzuki, Anjo-shi (JP); Kazunori Ishikawa, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/195,947

(22) Filed: Aug. 21, 2008

(30) Foreign Application Priority Data
Aug. 22, 2007 (JP) 2007-215474

(51) Int. Cl. F16H 45/02; F16H 61/14

(52) U.S. Cl. 192/3.31

(57) ABSTRACT

A lock-up clutch is arranged in parallel with a power transmission path between a pump impeller and a turbine runner of a fluid coupling arranged between the drive side and the load side, wherein the lock-up clutch changes the power transmission path. A stall capacity factor is determined using an engine speed at which the maximum engine torque on the drive side is generated, and the rotation on the drive side is transmitted to the load side by using the stall capacity factor. Therefore, optimal acceleration can be obtained by setting the stall capacity factor such that the stall rotational speed is in the vicinity of the rotational speed at which the maximum engine torque is generated. Thus, drivability can be improved by obtaining a control amount with which the vehicle speed responds as expected to the accelerator, there is no uncomfortable sensation, and fuel economy can be improved.

### CROSS-REFERENCE TO RELATED APPLICATIONS

This application claims priority from Japanese Patent Application No. 2007-215474 filed on Aug. 22, 2007, the disclosure of which, including the specification, drawings and abstract, is incorporated herein by reference in its entirety.

### BACKGROUND

1. Technical Field

Apparatuses consistent with the present invention relate to a hydraulic power transmission with a lock-up clutch that uses a fluid coupling of an automatic transmission of a vehicle or the like, and more specifically, relates to a hydraulic power transmission with a lock-up clutch in which the lock-up clutch is provided in the fluid coupling.

2. Description of the Related Art

Presently, there is a need for improved fuel economy in automobiles. When a torque converter is viewed in terms of improving the fuel economy of a vehicle, although the torque converter includes an operation in which the torque is amplified when the vehicle starts to move, when long distance travel is assumed, the fuel economy can still be further improved.

To address this, a technology that is disclosed in Japanese Patent Application Publication No. JP-A-2000-283188 is an example of a known hydraulic power transmission with a lock-up clutch. Japanese Patent Application Publication No. JP-A-2000-283188 discloses the technology of a hydraulic coupling device (1) that includes integrated cases (3, 4) that are connected to an engine output shaft (note that, here, the reference numerals that are enclosed in the parentheses indicate the structural components in the figures of Japanese Patent Application Publication No. JP-A-2000-283188); a turbine hub (30) that is connected to an input shaft (31) of a speed-change mechanism; a fluid coupling (11) that includes a pump impeller (7) and a turbine runner (10) that are provided in the integrated cases, the turbine runner (10) being connected to the turbine hub; and a lock-up clutch (13) that is interposed between the integrated cases and the turbine hub. The turbine hub (30), the fluid coupling (11), and the lock-up clutch (13) are accommodated in the integrated cases (3, 4). In the hydraulic coupling device (1), the lock-up clutch (13) is controlled by a piston member (20) that is operated based on the hydraulic pressure of a cylinder chamber (B); the inside of the integrated cases (3, 4) is partitioned so as to be oil tight by the piston member (20) into a fluid coupling chamber (A), which accommodates the fluid coupling (11) and the lock-up clutch (13), and the cylinder chamber (B); and an oil supply path that supplies a working fluid to the fluid coupling chamber (A), an oil discharge path that discharges the working fluid from the fluid coupling chamber (A), and an oil path for clutch control that communicates with the cylinder chamber (B) are each provided independently.

According to the above structure, the dedicated oil supply path and oil discharge path for circulating the working fluid of the fluid coupling chamber (A) are provided. Thus, it is possible to prevent the temperature of the working fluid from becoming high and the lock-up clutch (13) can be reliably lubricated. Further, because the dedicated oil path for clutch control communicates with the cylinder chamber (B) of the piston member (20), it is possible to control the lock-up clutch (13) with high precision and sensitivity.

However, although the technology of the hydraulic power transmission with a lock-up clutch disclosed in Japanese Patent Application Publication No. JP-A-2000-283188 enables good fuel economy by locking the lock-up clutch (13) at an early timing, unlike a fluid torque converter including a stator, the stator has been eliminated and, thus, there is a possibility that the acceleration performance will deteriorate because a desired torque is not generated when the vehicle starts to move.

In order to make the characteristics of the fluid coupling (11) conform to the characteristics of the engine of an automobile, the fluid coupling (11) can be specified from the drive side that receives the output of the engine and the torque on the drive side. A speed ratio e of the torque of the engine output shaft that is transmitted from the drive side (the integrated cases (3, 4) side) through the fluid coupling (11) to the load side (the input shaft (31) side) is represented by e=load side rotational speed/drive side rotational speed, and the relationship between this speed ratio e and a capacity factor C exhibits the characteristics shown in FIG. 1. Note that FIG. 1 is a characteristic diagram that shows the speed ratio e and the capacity factor C.

In this context, the value of the capacity factor C during a stall state, such as an idling state or a stopped state, that is, when the speed ratio e=0, is simply called a stall capacity factor Cs. Note that the torque T [N·m] on the drive side is represented by T=C·N². Here, N is the engine speed [rpm] on the drive side.

When this stall capacity factor Cs is small, the engine speed increases according to the amount of the depression of the accelerator pedal, and when the stall capacity factor Cs is large, the amount of the increase in the engine speed becomes small according to the amount of depression of the accelerator pedal.

Generally, because a sudden rise in the rotational speed is not good immediately after the automobile starts to move due to having depressed the accelerator pedal, the value of the stall capacity factor Cs is selected so as to establish an engine speed of about 2000 to 2500 [rpm]. Specifically, for example, the stall capacity factor Cs is set so as to establish an engine speed of about 2500 [rpm].

However, even if, hypothetically, it is possible to improve the fuel economy, in the case in which a hydraulic power transmission, that has the characteristics described above, is combined with a small displacement engine, in which the maximum engine torque is generated at a high rotational speed, there is a possibility that the acceleration performance cannot be improved because the maximum engine torque is not generated immediately after the automobile starts to move.

### SUMMARY

Exemplary embodiments of the present invention resolve such shortcomings and other shortcomings not described above. Also, the present invention is not required to overcome the shortcomings described above, and exemplary embodiments of the present invention may not overcome any of the problems described above. Aspects of the present invention provide a hydraulic power transmission with a lock-up clutch in which the maximum engine torque is generated when a vehicle starts to move and drivability is improved.

According to a first aspect of the present invention, a hydraulic power transmission with a lock-up clutch that is arranged between a drive side and a load side and performs power transmission, includes the lock-up clutch, that is arranged in parallel with a power transmission path between a pump impeller and a turbine runner of a fluid coupling, that is arranged between the drive side and the load side, and changes the power transmission path. A stall capacity factor [N·m/rpm²] is determined based on an engine speed at the maximum engine torque on the drive side, and rotation on the drive side is transmitted to the load side by using the stall capacity factor.

Note that, the term fluid coupling includes, as a technical concept, (but is not limited to) a fluid coupling and a torque converter, and may be what is referred to as either a fluid coupling or a torque converter. More specifically, the fluid coupling described above may be a fluid coupling including a turbine runner that is opposed to a pump impeller with a working fluid interposed therebetween. Further, the fluid coupling may be a torque converter including a stator that amplifies torque.

In addition, it is sufficient if the lock-up clutch described above is a lock-up clutch that is arranged in parallel with the power transmission path between the pump impeller and the turbine runner of the fluid coupling arranged between the drive side and the load side, and that switches the power transmission path. Note that, normally, a damper is provided in the power transmission path of the lock-up clutch, and this damper absorbs vibrations during travel. However, naturally, a structure that does not include a damper may be implemented consistent with the present invention.

In addition, when the stall capacity factor [N·m/rpm²] is determined based on the engine speed at the maximum engine torque on the drive side, the stall capacity factor may be determined based on any one of the shapes of the pump impeller and the turbine runner of the fluid coupling, the working fluid and the like.

Furthermore, when the stall capacity factor [N·m/rpm²] is determined based on the engine speed at the maximum engine torque on the drive side, it may be determined based on the engine speed at which the maximum engine torque on the drive side is generated. However, because this is largely dependent on engine characteristics on the drive side, the stall capacity factor may be determined based on an engine speed within a range of ±1000 [rpm] of the engine speed at which the maximum engine torque is generated.

In the hydraulic power transmission with a lock-up clutch according to a second aspect of the present invention, the determination based on the engine speed at which the maximum engine torque on the drive side is generated is a determination of the stall capacity factor based on an engine speed within a range of ±1000 [rpm] of the engine speed at which the maximum engine torque on the drive side is generated. Here, the determination of the stall capacity factor [N·m/rpm²] based on the engine speed at maximum torque on the drive side is not unambiguously determined based on the rotational speed at which the maximum engine torque on the drive side is generated. The stall capacity factor is determined based on a rotational speed within a range of ±1000 [rpm] of the engine speed, taking into consideration the characteristics of the engine.

In the hydraulic power transmission with a lock-up clutch according to a third aspect of the present invention, the stall capacity factor is set to 7.5 to 20.5 [N·m/rpm²]. Here, the stall capacity factor Cs may be a value that can be set within a range of 7.5 to 20.5 [N·m/rpm²].

Furthermore, a damper is further added to the lock-up clutch according to a fourth aspect of the present invention, and the lock-up clutch and the damper serve as a path that changes the power transmission path of the fluid coupling. Thus, there is provided a structure in which the damper that absorbs engine vibrations is provided in the power transmission path of the lock-up clutch.

The hydraulic power transmission with a lock-up clutch according to the first aspect of the present invention is provided with a lock-up clutch that is arranged in parallel with the power transmission path between the pump impeller and the turbine runner of the fluid coupling arranged between the drive side and the load side, and changes the power transmission path. The stall capacity factor [N·m/rpm²] is determined based on the engine speed at which the maximum engine torque on the drive side is generated, and the rotation on the drive side is transmitted to the load side by using this stall capacity factor.

Therefore, even in the case of a small displacement engine that generates the maximum engine torque at a high speed rotation, the best acceleration can be obtained by setting the stall capacity factor Cs such that the stall rotational speed is in the vicinity of the rotational speed at which the maximum engine torque is generated.

In particular, when viewing torque converters currently used in terms of improvement in fuel economy of a vehicle, although the torque converters serve to amplify torque when the vehicle starts to move, when long-distance travel is assumed, it is not possible to improve the fuel economy of the vehicle because the engine speed is transmitted to the wheels through the working fluid. However, it is difficult for the vehicle to start moving smoothly by using only the clutch control when the vehicle starts to move. Thus, by setting for the fluid coupling a value of the stall capacity factor Cs that has not been used, that is, by setting the stall capacity factor Cs to the engine speed at which the maximum engine torque is generated, and engaging the lock-up clutch at an earlier timing than normal, it is possible to transmit a necessary torque to the wheels. Thus, it is possible to ensure the acceleration performance. In particular, at this time, it is possible to improve drivability by obtaining a control amount with which the vehicle speed is responding as expected to the depression amount of the accelerator pedal and there is no uncomfortable sensation.

In the hydraulic power transmission with a lock-up clutch according to the second aspect of the present invention, the determination based on the engine speed at which the maximum engine torque on the drive side is generated is a determination of the stall capacity factor based on an engine speed within a range of ±1000 [rpm] of the engine speed at which the maximum engine torque on the drive side is generated. Therefore, in addition to the effects obtained by the first aspect of the present invention, the stall capacity factor is not unambiguously limited to the specific rotational speed at the maximum engine torque. In order to obtain a torque that is equal to or greater than that of a related art apparatus, a rotational speed within a range of ±1000 [rpm] of the engine speed at which the maximum engine torque is generated is targeted. Thus, when being combined with a small displacement engine, an approximately maximum engine torque is generated immediately after the vehicle starts to move, and it is possible to improve the acceleration performance.

In the hydraulic power transmission with a lock-up clutch according to the third aspect of the present invention, the stall capacity factor is set to 7.5 to 20.5 [N·m/rpm²]. Therefore, in addition to the effects obtained by the first or the second aspect of the present invention, it is confirmed that the fuel economy and drivability are good from the results of experiments performed by the inventors.

Furthermore, a damper is further added to the lock-up clutch of the hydraulic power transmission with a lock-up clutch according to the fourth aspect of the present invention, and the lock-up clutch and the damper serve as a path that changes the power transmission path of the fluid coupling. Therefore, in addition to the effects obtained by any one of the first to the third aspects of the present invention, the rotational vibrations of the engine during travel can be absorbed by the damper that is provided in the power transmission path of the lock-up clutch, and smooth rotation can be obtained.

### BRIEF DESCRIPTION OF THE DRAWINGS

The aspects of the present invention will become more apparent by describing in detail exemplary embodiments thereof with reference to the accompanying drawings, in which:

FIG. 1 is a characteristic diagram that shows the speed ratio and the stall capacity factor;

FIG. 2 is a drawing of a longitudinal section that shows the hydraulic power transmission with a lock-up clutch of an exemplary embodiment of the present invention;

FIG. 3 is a characteristic diagram that shows a comparison of the characteristic diagrams of the hydraulic power transmission with a lock-up clutch of an exemplary embodiment of the present invention and a related art apparatus;

FIG. 4 is a characteristic diagram that shows a comparison of the acceleration performances of the hydraulic power transmission with a lock-up clutch of an exemplary embodiment of the present invention and a hydraulic power transmission with a lock-up clutch of the related art;

FIG. 5 is a characteristic diagram that shows a comparison of the engine speeds due to differences in the engagement pressures of the hydraulic power transmission with a lock-up clutch of an exemplary embodiment of the present invention and the hydraulic power transmission with a lock-up clutch of the related art;

FIG. 6 is a characteristic diagram that shows a hydraulic power transmission with a lock-up clutch of the related art in which the stall capacity factor Cs=30;

FIG. 7 is a characteristic diagram that shows the hydraulic power transmission with a lock-up clutch of an exemplary embodiment of the present invention in which the stall capacity factor Cs=20.5;

FIG. 8 is a characteristic diagram that shows the hydraulic power transmission with a lock-up clutch of an exemplary embodiment of the present invention in which the stall capacity factor Cs=15;

FIG. 9 is a characteristic diagram that shows the hydraulic power transmission with a lock-up clutch of an exemplary embodiment of the present invention in which the stall capacity factor Cs=12.5;

FIG. 10 is a characteristic diagram that shows the hydraulic power transmission with a lock-up clutch of an exemplary embodiment of the present invention in which the stall capacity factor Cs=10.15;

FIG. 11 is a characteristic diagram that shows the hydraulic power transmission with a lock-up clutch of an exemplary embodiment of the present invention in which the stall capacity factor Cs=7.5; and

FIG. 12 is a characteristic diagram in which the characteristic diagrams of various stall capacity factors in the hydraulic power transmission with a lock-up clutch of an exemplary embodiment of the present invention are superimposed.

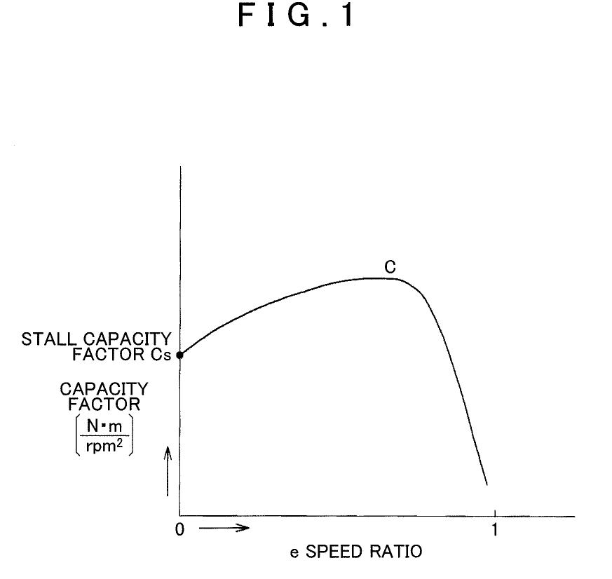

### DETAILED DESCRIPTION OF EXEMPLARY EMBODIMENTS

Hereinafter, exemplary embodiments of the present invention will be explained with reference to the drawings. Note that, in the exemplary embodiments, identical reference symbols and identical reference numerals denote identical or corresponding functional components, and thus, redundant explanations will be omitted here.

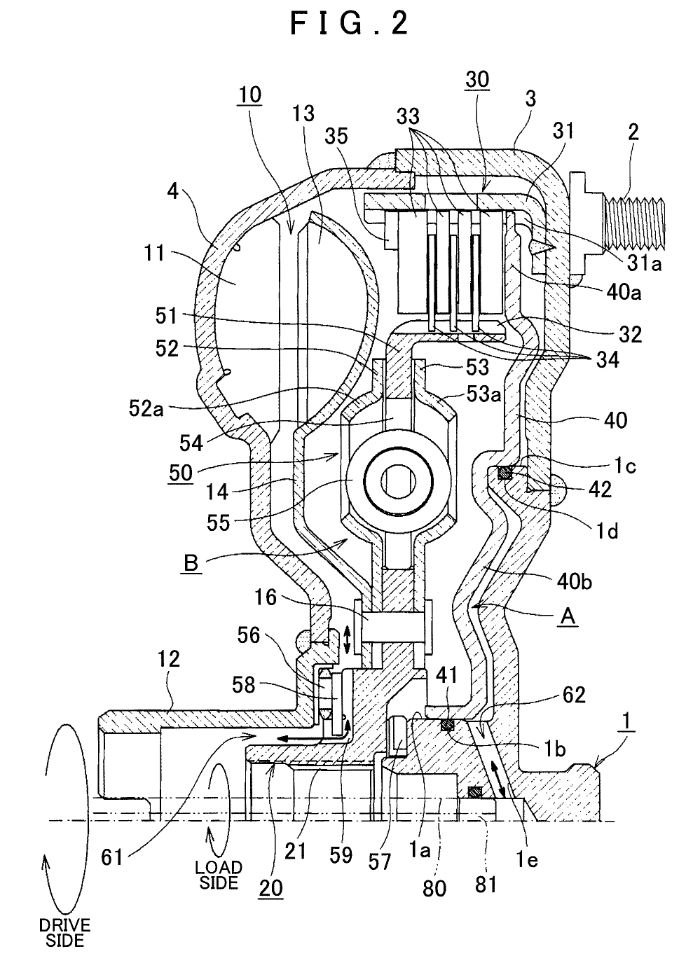

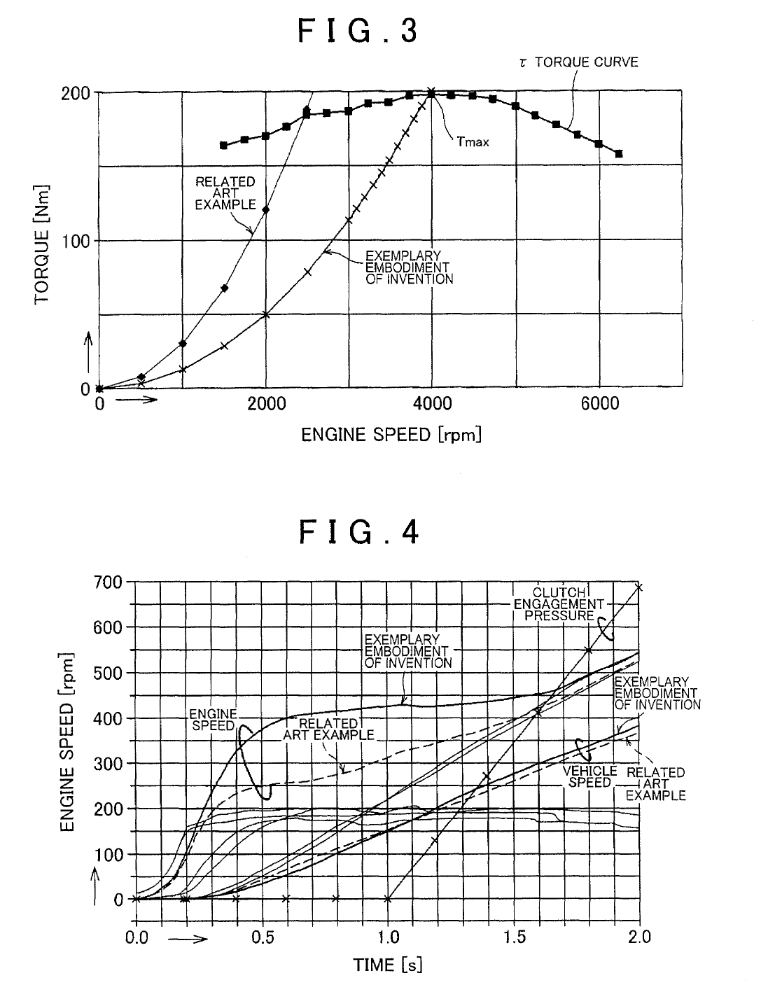

FIG. 2 is a drawing of a longitudinal section that shows the hydraulic power transmission with a lock-up clutch of an exemplary embodiment of the present invention. FIG. 3 is a characteristic diagram that shows a comparison of the characteristic diagrams of the hydraulic power transmission with a lock-up clutch of an exemplary embodiment of the present invention and a related art apparatus.

In FIG. 2, a pin 2 and a center piece 1, that are attached to a front cover 3, are on the drive side and are connected to an internal combustion engine such as a gasoline engine (not illustrated). A turbine hub 20 is connected to a speed change mechanism on the drive side by a spline 21.

The center piece 1 and the pin 2 on the drive side are integrated with the front cover 3 and a rear cover 4, and the pin 2 that is attached to the front cover 3 is connected to the engine crank shaft side via a drive plate (not illustrated). These are accommodated in a coupling housing (not illustrated), and the coupling housing is connected to the side of the shaft that enters the engine block on the right side of FIG. 2 and the transmission case on the left side of FIG. 2.

The outer shell of a pump impeller 11 is formed by a portion of the rear cover 4, and in addition, a cover boss 12 is integrated at the inner diameter end of the rear cover 4 by welding. A turbine runner 13 is disposed opposite to the pump impeller 11 and has a shape that is substantially identical thereto. The pump impeller 11 and the turbine runner 13 form a fluid coupling 10 that transmits the power through a working fluid (fluid).

A lock-up clutch 30, which is formed by a multi-plate clutch, is accommodated inside the front cover 3. The lock-up clutch 30 includes a drum member 31 that is attached to the inside of the front cover 3, a clutch hub 32 that is attached to the turbine hub 20, a plurality of clutch plates 33 having an outer diameter side that fits into a spline on the drum member 31, and clutch disks 34 having an inner diameter side which fits into a spline on the clutch hub 32 and to which friction members are attached. These clutch plates 33 and clutch disks 34 are alternately disposed, and the separation of the clutch plates 33 and the like is prevented by a snap ring 35 that is mounted on the distal end portion of the drum member 31.

The drum member 31 has a rounded shape that has a substantially L-shape in cross section, a spline 31a is formed on the inner periphery thereof, the outer diameter side thereof is arranged such that a slight gap is provided between the drum member 31 and the outer peripheral portion of the front cover 3, and the surface in a substantially radial direction is integrally attached to a portion of the front cover 3 by welding.

The piston member 40 cooperates to form the cylinder chamber A with a boss portion outer peripheral surface 1a of the center piece 1 of the front cover 3, the inner diameter side surface of the center piece 1, on the left side of FIG. 2, which has a diameter that is larger than that of the boss portion outer peripheral surface 1a, and the outer peripheral surface of a stepped portion 1c of the center piece 1.

Specifically, the piston member 40 has a piston portion 40b that cooperates to form the cylinder chamber A. In the boss portion outer peripheral surface 1a, an annual groove 1b is formed that accommodates an O-ring 41 that is in sliding contact with the inner peripheral surface of the piston portion 40b and an annual groove 1d is formed that accommodates an O-ring 42 that is in sliding contact with the outer peripheral surface of the stepped portion 1c of the center piece 1, and they are oil tightly engaged. Thus, the cylinder chamber A is formed to be closed with a portion of the front cover 3.

The piston member 40 that forms this circular cylinder chamber A has a pressing portion 40a on the distal end thereof that presses the clutch plates 33, and the pressing portion 40a opposes one end surface of the clutch plates 33 and operates the lock-up clutch 30.

The clutch hub 32 is formed such that the outer diameter end of a disk-shaped drive plate 51 of a damper 50 curves in an axial direction. The damper 50 is disposed so as to enclose a drive plate 51, and is formed by two driven plates 52 and 53 that are integrally connected, and a coil spring 55 that is a vibration absorbing device. The coil spring 55 is received by a long hole 54 that is formed in the peripheral direction of the drive plate 51, and expanded portions 52a and 53a that are respectively formed on the driven plates 52 and 53. The coil spring 55 is compressed due to the relative rotation of the drive plate 51 and the driven plates 52 and 53, and absorbs rapid torque fluctuations between the plates. Note that, instead of the coil spring 55, the damper 50 according to an exemplary embodiment of the invention may use, for example, a flat spring or hydraulic pressure.

The base end portions of the two driven plates 52 and 53 are integrally fixed to the turbine hub 20 by a plurality of rivets 16. In addition, a turbine runner base portion 14 that extends in the outer diameter direction and forms the turbine runner 13 at an end thereof is integrally fixed by the rivets 16. The turbine hub 20 is connected to the output shaft (not illustrated) by the spline 21, and the output shaft extends toward an automatic speed change mechanism and the like.

Further, a thrust bearing 56 is disposed between the turbine hub 20 and a flange surface of the rear cover boss 12. In addition, a thrust bearing (thrust washer) 57 is also interposed between a right front surface of the turbine hub 20 and a left rear end surface of the center piece 1. The turbine hub 20, the driven plates 52 and 53 that are integrated therewith, and the turbine runner 13 that is disposed at a free end of the turbine runner base portion 14 freely rotate integrally with the turbine hub 20 inside the front cover 3 and the rear cover 4 via the thrust bearing 56 and the thrust bearing 57. Furthermore, the turbine hub 20 is clamped by the driven plates 52 and 53, and the driven plates 52 and 53 and the clutch hub 32, which are supported via the coil spring 55, are also supported similarly.

In this manner, according to an exemplary embodiment of the present invention, the inside of the case that is formed by the integrated front cover 3 and the rear cover 4 is partitioned into a fluid coupling chamber B that houses the fluid coupling 10, the lock-up clutch 30, and the damper 50, and a cylinder chamber A that is separated from the fluid coupling chamber B so as to be oil-tight by the piston portion 40b of the piston member 40 and the O-rings 41 and 42.

In addition, an oil path 81 that extends in an axial direction is formed in the center of an input shaft 80 that is connected to the center piece 1 on the drive side. Further, a flat ring-shaped thick-walled race 58 that supports a roller is provided on the thrust bearing 56 between the thrust bearing 56 and the turbine hub 20. A plurality of annual grooves 59 are formed in the surface of the turbine hub 20 that abuts against the thick-walled race 58. The annular grooves 59 communicate with the fluid coupling chamber B, and form a first oil path 61 through which the working fluid is supplied to and discharged from the fluid coupling chamber B.

In addition, the distal end of the oil path 81 that is formed in the input shaft 80 is inserted into a center recess of the center piece 1, and communicates with oil paths 1e so as to be oil-tight. The plurality of oil paths 1e that pass through the boss portion of the center piece 1 communicate with the cylinder chamber A. Therefore, the oil paths 1e of the center piece 1 structure a second oil path 62 through which working fluid is supplied to and discharged from the cylinder chamber A.

Next, the operation of the hydraulic power transmission with a lock-up clutch of an exemplary embodiment of the present invention will be explained.

[Stall State]

First, before the vehicle starts to move, a lock-up relay valve (not illustrated) is in a drain state, and the working fluid in the cylinder chamber A is discharged through the second oil path 62. In this state, the piston member 40 is in the illustrated state, and the lock-up clutch 30 is in a released state. More specifically, the pressure on the clutch plates 33 and the clutch disks 34 has been released by the pressing portion 40a of the piston member 40, and both plates are in a state in which there is no torque capacity caused by friction. This state is maintained until immediately before the vehicle starts to move.

Note that this stall state denotes a state in which, because the pump impeller 11 and the turbine runner 13 are arranged with the working fluid present therebetween, generally, the pump impeller 11 rotates at a rotational speed that is identical to the engine speed and the rotation of the turbine runner 13 is stopped. The stall capacity factor Cs denotes the torque capacity that can be transmitted via the working fluid in this state. Naturally, the stall capacity factor Cs varies depending on the manner in which the working fluid flows due to the shapes and angles and the like of the blades of the pump impeller 11 and the turbine runner 13.

[Transmission State Using Only the Fluid Coupling]

When the vehicle starts to move, the torque from the drive side is transmitted from the front cover 3 to the pump impeller 11 of the fluid coupling 10. The turbine runner 13 rotates via the flow of the working fluid caused by the rotation of the pump impeller 11. Because the turbine runner base portion 14, the driven plates 52 and 53, and the turbine hub 20 are integrally attached by the rivets 16, the rotation of the turbine hub 20 is transmitted to the load side, and then transmitted to the drive wheels via the automatic speed change mechanism.

During this time period, the working fluid is supplied to the fluid coupling chamber B via the first oil path 61, and power is transmitted to the turbine hub 20 while the working fluid serving as the power transmission medium circulates between the pump impeller 11 and the turbine runner 13 of the fluid coupling 10.

[Transmission State Using the Fluid Coupling and the Lock-Up Clutch]

When the output of the turbine hub 20 has reached a relatively low predetermined speed, a lock-up relay valve (not illustrated) is switched to a supply state. In this state, hydraulic pressure is supplied from the oil path 81 formed in the input shaft 80, via the oil paths 1e of the center piece 1, that is, through the second oil path 62, to the cylinder chamber A, and the piston portion 40b of the piston member 40 moves toward the left in FIG. 2. Thus, the pressing portion 40a of the piston portion 40 presses the clutch plates 33. As a result, frictional force is generated between the clutch plates 33 and the clutch disks 34, and the lock-up clutch 30 carries a predetermined torque capacity.

In this state, the torque on the drive side is transmitted to the damper 50 via the front cover 3 and the lock-up clutch 30, and then transmitted to the load side via the turbine hub 20. More specifically, the torque of the front cover 3 is transmitted to the drum member 31, the clutch plates 33, the clutch disks 34, and the driven plate 51. Then, rapid fluctuations in the torque accompanied by, for example, the connection of the lock-up clutch 30 or torque oscillation of the engine, are absorbed by the coil spring 55, the torque is transmitted to the driven plates 52 and 53, and then transmitted to the turbine hub 20.

During this time period, the torque from the drive side is transmitted from the front cover 3 to the pump impeller 11, and the turbine runner 13 rotates via the flow of the working fluid based on the rotation of the pump impeller 11. Because the turbine runner base portion 14, the driven plates 52 and 53, and the turbine hub 20 are integrally attached by the rivets 16, the rotation of the turbine hub 20 is transmitted to the output shaft.

More specifically, when the supply of the hydraulic pressure to the cylinder chamber A is adjusted via the second oil path 62, the pressing force that the pressing portion 40a of the piston member 40 applies to the clutch plates 33 and the clutch disks 34 is adjusted, and the torque capacity of the lock-up clutch 30 based on the frictional force therebetween is adjusted. Thus, the lock-up clutch 30 transmits the drive side torque, that is, transmits the torque while causing the clutch plates 33 and the clutch disks 34 to slip by a predetermined amount. This is referred to as slip control.

[Lock-Up State]

When the hydraulic pressure is maximally supplied to the cylinder chamber A via the second oil path 62, the pressing force that the pressing portion 40a of the piston member 40 applies to the clutch plates 33 and the clutch disks 34 reaches a maximum, and the slip of the lock-up clutch 30 based on the frictional force therebetween ends, and the lock-up state is established. Thus, the lock-up clutch 30 comes into a direct coupled state, the drive-side torque is transmitted to the turbine hub 20 via the clutch plates 33 and the clutch disks 34, and the torque is transmitted from the drive side to the load side without the fluid coupling 10. In this state, the engine speed and torque can be directly transmitted via the lock-up clutch 30 without using the fluid coupling 10. Therefore, it is possible to improve the fuel economy to the maximum extent.

Here, the characteristic diagram that is shown in FIG. 3, which determines the stall capacity factor Cs based on the engine speed, is used to compare the characteristics of the hydraulic power transmission with a lock-up clutch of an exemplary embodiment of the invention and the characteristics of a related art example when using a small displacement engine that has a comparatively high engine speed that attains a high speed rotation at the maximum engine torque Tmax.

As shown in FIG. 3, the engine that is used in the tests has a torque that is shown by the torque characteristic τ. In related art, the engine speed is set to 2500 [rpm], and this is set as the stall rotational speed. Therefore, when the engine is mounted in an automobile and the automobile starts moving, a torque that is about 10% to 20% lower than the maximum engine torque is used, and thus acceleration is not sufficiently provided, and the drivability deteriorates.

According to an exemplary embodiment of the present invention, an engine having a torque characteristic τ that is identical to that of the related art example is used, and the engine speed of 4000 [rpm] at the maximum engine torque Tmax, which is represented by the torque characteristic τ, is set as the stall rotational speed. Therefore, in the case in which the engine is mounted in an automobile and the automobile starts moving, because the maximum engine torque Tmax is provided, sufficient acceleration is provided, and the drivability is improved.

FIG. 4 is a characteristic diagram that shows a comparison of the acceleration performances of the hydraulic power transmission with a lock-up clutch of an exemplary embodiment of the present invention and a hydraulic power transmission with a lock-up clutch of related art. FIG. 5 is a characteristic diagram that shows a comparison of the engine speeds due to differences in the engagement pressures of the hydraulic power transmission with a lock-up clutch of an exemplary embodiment of the present invention and the hydraulic power transmission with a lock-up clutch of related art.

More specifically, as shown in FIG. 4, the time from the start of movement to the start of the operation of the lock-up clutch, which is shown in the sections [Transmission state using only the fluid coupling] to [Transmission state using the fluid coupling and the lock-up clutch] described above, is set to 1 second. The time from the start of the operation of the lock-up clutch 30 to the lock-up is set to 1 second. That is, the time from the start of movement to the start of the operation of the lock-up clutch is set to 1 second, and the time from the start of the operation of the lock-up clutch 30 to the lock-up is set to 1 second, and thus the lock-up is completed in 2 seconds. The interval from the start of the operation of the lock-up clutch 30 to the lock-up is proportional to time.

Based on FIG. 4, it can be understood that up to the [Transmission state using only the fluid coupling] and the [Transmission state using the fluid coupling and the lock-up clutch] described above, the engine speed of the present exemplary embodiment is larger than that of the related art example. In the related art example, the engine speed fluctuates by about 50 [rpm] between 0.6 seconds and 1 second, while in the present exemplary embodiment, the fluctuation of the engine speed is only 25 [rpm]. With respect to vehicle speed, the acceleration of the present exemplary embodiment is better than that of the related art example.

In addition, even after the [Transmission state using the fluid coupling and the lock-up clutch] described above, the engine speed of the present exemplary embodiment fluctuates less than that of the related art example, and shows that it is possible to make the stall capacity factor Cs small.

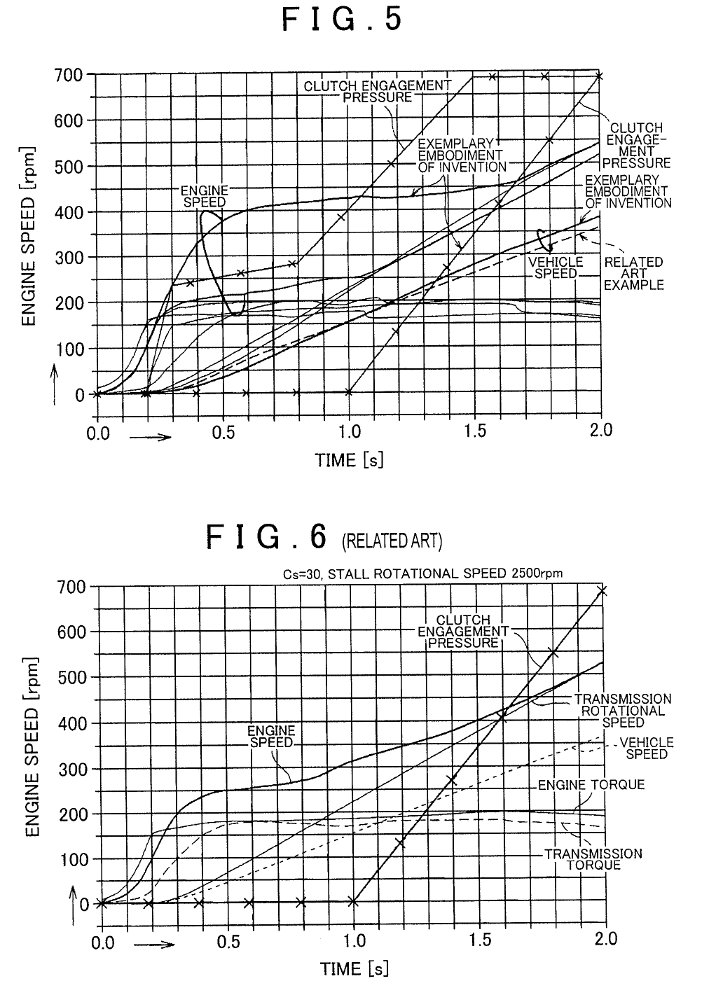

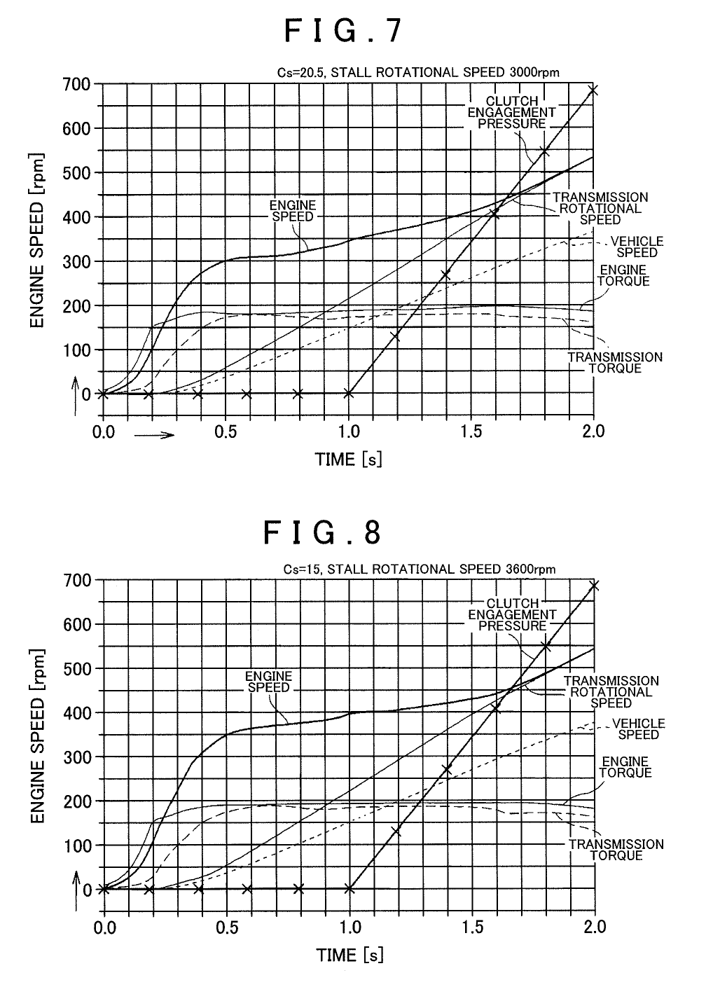

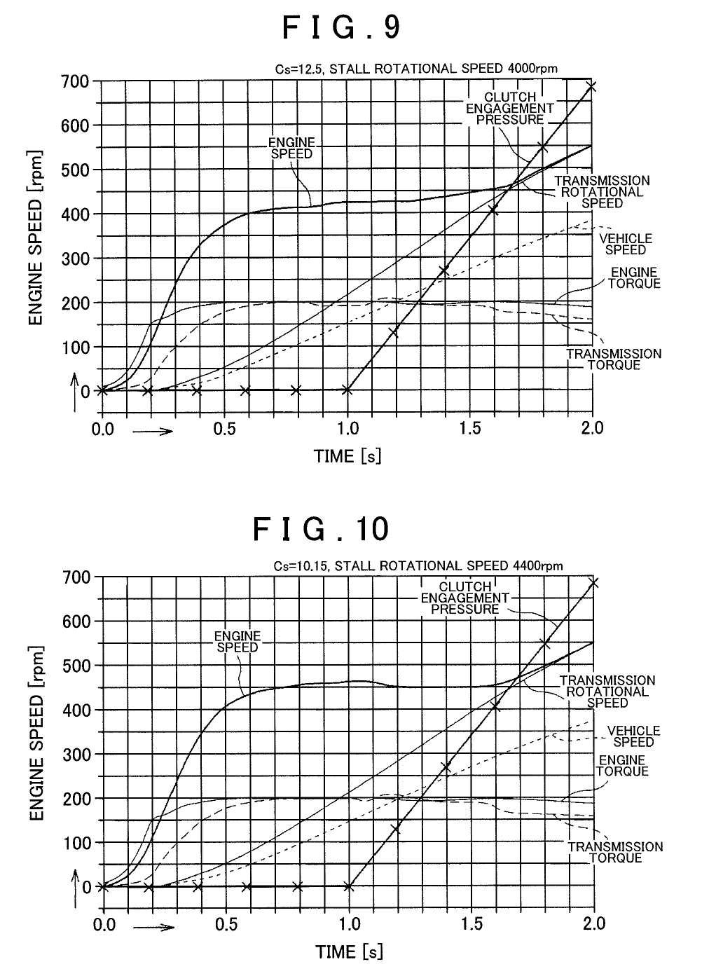

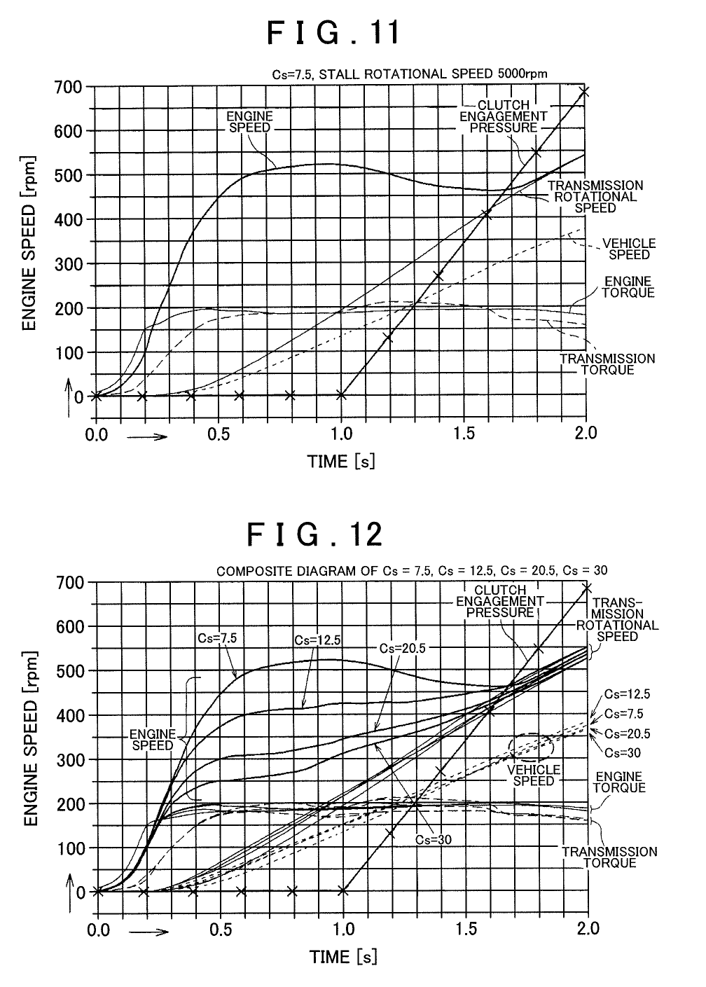

FIG. 6 is a characteristic diagram that shows a hydraulic power transmission with a lock-up clutch of related art in which the stall capacity factor Cs=30. FIG. 7 is a characteristic diagram that shows the hydraulic power transmission with a lock-up clutch of an exemplary embodiment of the present invention in which the stall capacity factor Cs=20.5. FIG. 8 is a characteristic diagram that shows the hydraulic power transmission with a lock-up clutch of an exemplary embodiment of the present invention in which the stall capacity factor Cs=15. FIG. 9 is a characteristic diagram that shows the hydraulic power transmission with a lock-up clutch of an exemplary embodiment of the present invention in which the stall capacity factor Cs=12.5. FIG. 10 is a characteristic diagram that shows the hydraulic power transmission with a lock-up clutch of an exemplary embodiment of the present invention in which the stall capacity factor Cs=10.15. FIG. 11 is a characteristic diagram that shows the hydraulic power transmission with a lock-up clutch of an exemplary embodiment of the present invention in which the stall capacity factor Cs=7.5. FIG. 12 is a characteristic diagram in which the characteristic diagrams of various stall capacity factors in the hydraulic power transmission with a lock-up clutch of an exemplary embodiment of the present invention are superimposed.

FIG. 6 is a characteristic diagram that shows a hydraulic power transmission with a lock-up clutch of related art in which the stall capacity factor Cs=30, and the stall capacity factor is 2500 [rpm]. As described above, a torque that is about 10% to 20% lower than the maximum engine torque Tmax is used, and the stall capacity factor Cs=30. Therefore, the vehicle speed increases with time, but the acceleration is not sufficiently provided, and the drivability is not good.

In the case of the characteristic diagram in FIG. 7, the engine speed rises from the start of movement, in the sequence of the stall capacity factors Cs=20.5, . . . , 12.5, . . . , 7.5, as shown in FIG. 12, and the vehicle speed provides sufficient acceleration at a value that is smaller than the stall capacity factor Cs=20.5, and the drivability is improved. However, when the stall capacity factor Cs=7.5, the racing of the initial engine speed becomes large, and when the stall capacity factor Cs falls below 7.5, there is a possibility of excessive racing.

In addition, when based on the engine speed of 4000 [rpm] that generates the maximum engine torque Tmax on the drive side in the exemplary embodiment described above, the stall capacity factor Cs may be set centered on an engine speed of 4000 [rpm], which generates the maximum engine torque Tmax on the drive side, based on a rotational speed in a range of 4000±1000 [rpm], that is, a range of 3000 to 5000 [rpm]. Here, because the torque reduction is only equal to or less than 10% of the maximum engine torque Tmax, this is more advantageous than the known technology that uses a torque that is 10% to 20% lower.

In addition, the timing for the operation of the fluid coupling 10 and the lock-up clutch 30 in the exemplary embodiment described above starts the operation of the lock-up clutch 30 when one second has passed from the start of the movement. However, as shown in FIG. 5, if the operation starting point of the lock-up clutch 30 is from 0.8 seconds to 1.2 seconds, then the fuel economy and the drivability are favorable.

The hydraulic power transmission with a lock-up clutch of the exemplary embodiment described above is provided with the fluid coupling 10 and the lock-up clutch 30. The fluid coupling 10 that is disposed between the drive side and the load side and performs power transmission includes the pump impeller 11 and the turbine runner 13 that opposes the pump impeller 11 with the working fluid interposed therebetween. The lock-up clutch 30 is arranged in parallel with a power transmission path between the pump impeller 11 and the turbine runner 13, is arranged between the drive side and the load side, and changes the power transmission path. In addition, in the hydraulic power transmission with a lock-up clutch of the above exemplary embodiment, the stall capacity factor Cs is determined based on the engine speed at which the maximum engine torque Tmax on the drive side is generated, and the rotation on the drive side is transmitted to the load side by using the determined stall capacity factor Cs.

Therefore, in the case of a small displacement engine that attains a high rotational speed at the maximum engine torque Tmax, when the stall rotational speed is small, such as 2500 [rpm], the maximum engine torque Tmax is not generated immediately after the movement starts, and thus even if the output of the engine is transmitted directly to the wheels, the necessary acceleration performance is not obtained. However, according to exemplary embodiments of the present invention, this problem is eliminated. That is, a favorable acceleration is obtained by setting the stall capacity factor Cs such that the stall rotational speed is in the vicinity of the rotational speed that generates the maximum engine torque Tmax.

In particular, when viewing present torque converters in terms of improvement in the fuel economy of a vehicle, although they act to amplify the torque when the vehicle starts to move, when long-distance travel is assumed, the engine speed is transmitted to the wheels through a working fluid, and it is not possible to improve the fuel economy of the vehicle. Thus, it is difficult for the vehicle to start to move smoothly by control of only the clutches when the vehicle starts to move. Thus, by setting the fluid coupling to a value of the stall capacity factor Cs that has not been used, that is, setting the stall capacity factor Cs to the engine speed at which the maximum engine torque is generated, and engaging the lock-up clutch at an earlier timing than normal, it is possible to transmit the necessary torque to the wheels, and it is possible to ensure the acceleration performance. In particular, under such circumstances, it is possible to improve drivability by obtaining a control amount with which the vehicle speed responds as expected to the depression amount of the accelerator pedal and there is no uncomfortable sensation.

Furthermore, the timing of the operation of the lock-up clutch 30 in the above-described exemplary embodiment starts the lock-up 1 second from the start of the movement, and after the start of this lock-up, the lockup is completed after 1 second. However, if the completion of the lock-up is 0.8 to 1 seconds after the start of movement, then the fuel economy and drivability are advantageous.

In addition, the damper 50 is further added to the lock-up clutch 30 in the above-described exemplary embodiment, and the lock-up clutch 30 and the damper 50 serve as paths that change the power transmission path of the fluid coupling 10. However, when implementing exemplary embodiments of the present invention, the function of the damper 50 that absorbs engine vibrations in the power transmission path of the lock-up clutch 30 may be omitted.

In addition, it has been explained above that in the related art example shown in FIG. 3, a torque that is about 10% to 20% lower than the maximum engine torque Tmax is used, and thus acceleration is not sufficiently provided and the drivability is bad. If a torque converter is used instead of the fluid coupling of this exemplary embodiment, the torque converter amplifies the torque in a low rotational speed region of the engine, and thus in comparison to the fluid coupling, the drivability does not significantly deteriorate.

In addition, according to an exemplary embodiment of the present invention, when the engine is mounted in an automobile and the automobile starts moving, the maximum engine torque Tmax is provided. Thus, a sufficient acceleration is provided, and drivability is improved. However, even when a torque converter is used instead of the fluid coupling, if the lock-up clutch is engaged immediately after the automobile starts to move, the same result can be obtained.

It is contemplated that numerous modifications may be made to the exemplary embodiments of the invention without departing from the spirit and scope of the embodiments of the present invention as defined in the following claims.

What is claimed is:

1. A hydraulic power transmission, comprising:
a fluid coupling that is arranged between a drive side and a load side to perform power transmission, wherein and the fluid coupling includes:
a pump impeller;
a turbine runner that is opposed to the pump impeller; and
a working fluid interposed between the pump impeller and the turbine runner; and
a lock-up clutch that is arranged in parallel with a power transmission path between the pump impeller and the turbine runner arranged between the drive side and the load side,
wherein the lock-up clutch is configured to change the power transmission path,
wherein rotation of the drive side is transmitted to the load side by using a stall capacity factor, and
wherein the stall capacity factor is determined using an engine speed at which a maximum engine torque on the drive side is generated.

2. The hydraulic power transmission according to claim 1, wherein the stall capacity factor is determined using an engine speed within a range of ±1000 rpm of the engine speed at which the maximum engine torque on the drive side is generated.

3. The hydraulic power transmission according to claim 2, wherein the stall capacity factor is set in a range of 7.5 to 20.5 N·m/rpm².

4. The hydraulic power transmission according to claim 3, further comprising a damper,
wherein the lock-up clutch and the damper are configured to comprise a path that changes the power transmission path of the fluid coupling.

5. The hydraulic power transmission according to claim 1, wherein the stall capacity factor is set in a range of 7.5 to 20.5 N·m/rpm².

6. The hydraulic power transmission according to claim 5, further comprising a damper,
wherein the lock-up clutch and the damper are configured to comprise a path that changes the power transmission path of the fluid coupling.

7. The hydraulic power transmission according to claim 1, further comprising a damper,
wherein the lock-up clutch and the damper are configured to comprise a path that changes the power transmission path of the fluid coupling.

8. The hydraulic power transmission according to claim 1, wherein the stall capacity factor is determined using at least one of a shape of the pump impeller, a shape of the turbine runner, and a property of the working fluid.
